(19) United States
(12) Patent Application Publication
(10) Pub. No.: US 2004/0051842 A1
(43) Pub. Date: Mar. 18, 2004

(54) Eyeglasses assembly

(76) Inventor: Kuo-Tseng Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/233,655

(22) Filed: Sep. 4, 2002

(51) Int. Cl. G02C 1/00

(52) U.S. Cl. 351/78

(57) ABSTRACT

A eyeglasses assembly comprises a frame, a pad and lens. The frame has a nose-stand in the form of inverted V in the middle of eyeglasses assembly. The both sides of nose stand of frame has at least a pillar, respectively, connect to hole of frame. In the middle of pad also has an inverted V nose stand. The pad also has at least a flange. The nose-stand of pad connects to the hole of nose stand of frame, and so the flange of pad connects to hole of frame. Further, the present invention provides a replaceable pad to combine frame easily without any tool. Furthermore, the eyeglasses assembly of present invention is conveniently and pleasing to the eye for user.

### FIELD OF THE INVENTION

The present invention relatives to a eyeglasses assembly, especially, is made of both hard and soft materials. Further, the eyeglasses frame of present invention has replaceable and soft pad.

### BACKGROUND OF THE INVENTION

In generally, the eyeglasses assembly is made of soft and hard materials as one, like safety eyeglasses for industry, sunglasses, sport-eyeglasses, but the pad of eyeglasses cannot be replaced. If the pad wear and tear or for other uses, the pad cannot be replaced and shall be buy another ones. The eyeglasses with replaceable pad, in conventionally, has come off easily and joints not firm. It is uncomfortable for user wearing.

Therefore, as above described, the present invention provides an eyeglasses assembly has firm joints, comfortable for user wearing and pleasuring to eyes.

### SUMMARY OF THE INVENTION

The purpose of present invention provides the eyeglasses assembly, made of soft and hard materials. The pad of said eyeglasses assembly is made of soft materials, connect to frame of said eyeglasses with strong joints can firm and not has come off easily.

Further, the purpose of present invention provides the eyeglasses assembly has replaceable pad. The pad is made of soft materials and replaced easily. The pad and face can match well, like sharp nose with think pad, flat nose with thick pad, for more comfortable and beautiful. Furthermore, the purpose of present invention provides an eyeglasses frame having a replaceable pad for different color matching user dresses.

The eyeglasses of present invention, comprising a frame and a pad, the said frame is made of hard materials. The pad is made of soft materials, softer than frame.

In the middle of said frame has a nose stand in the form of inverted V. The said nose stand has at least a pillar. The said frame has at least a hole.

In the middle of the pad has an inverted V nose stand. The pad is inside the frame. The nose-stand of pad connects to the hole of frame. The hole of frame connects to the lump of pad.

For the purpose of illustrating the invention, there is shown in the drawings several forms that are presently preferred, it being understood.

### BRIEF DESCRIPTION OF THE DRAWINGS

FIG. 1 is a three-dimensional view illustrating the preferred embodiment in present invention;

FIG. 2 is a decompose view illustrating the preferred embodiment in present invention;

FIG. 3A is a front view illustrating the frame of the preferred embodiment in present invention;

FIG. 3B is a vertical view illustrating the frame of the preferred embodiment in present invention;

FIG. 4A is a front view illustrating the pad of the preferred embodiment in present invention;

FIG. 4B is a vertical view illustrating the pad of the preferred embodiment in present invention;

FIG. 5A is a front view illustrating the frame of another preferred embodiment in present invention;

FIG. 5B is a front view illustrating the pad of another preferred embodiment in present invention;

FIG. 6 is a decompose view illustrating another preferred embodiment in present invention;

### DETAILED DESCRIPTION OF THE PREFERRED EMBODIMENTS

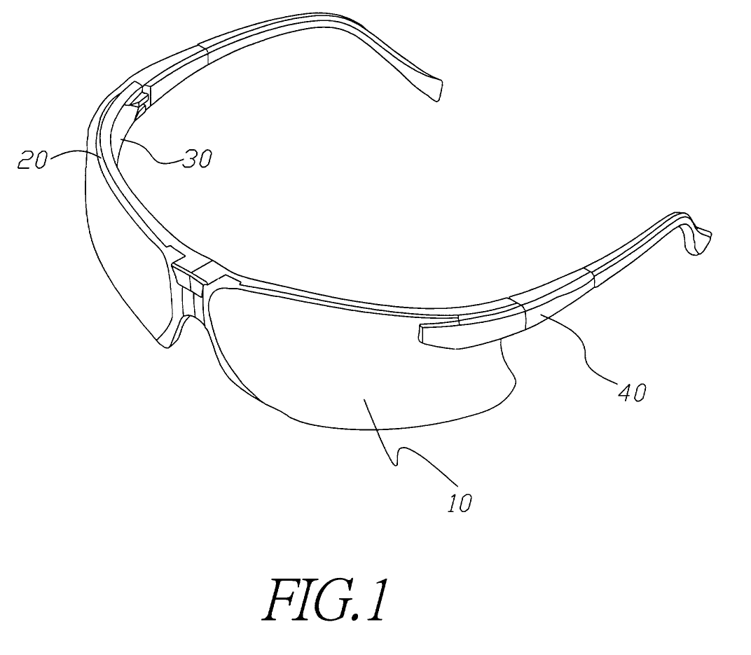

Reference to FIG. 1 is a three-dimensional view illustrating the preferred embodiment in present invention. The eyeglasses comprise a frame 20, a pad 30 inside the frame, and two legs 40 of eyeglasses connect to frame, respectively. A lens 10 is placed outside the frame 20.

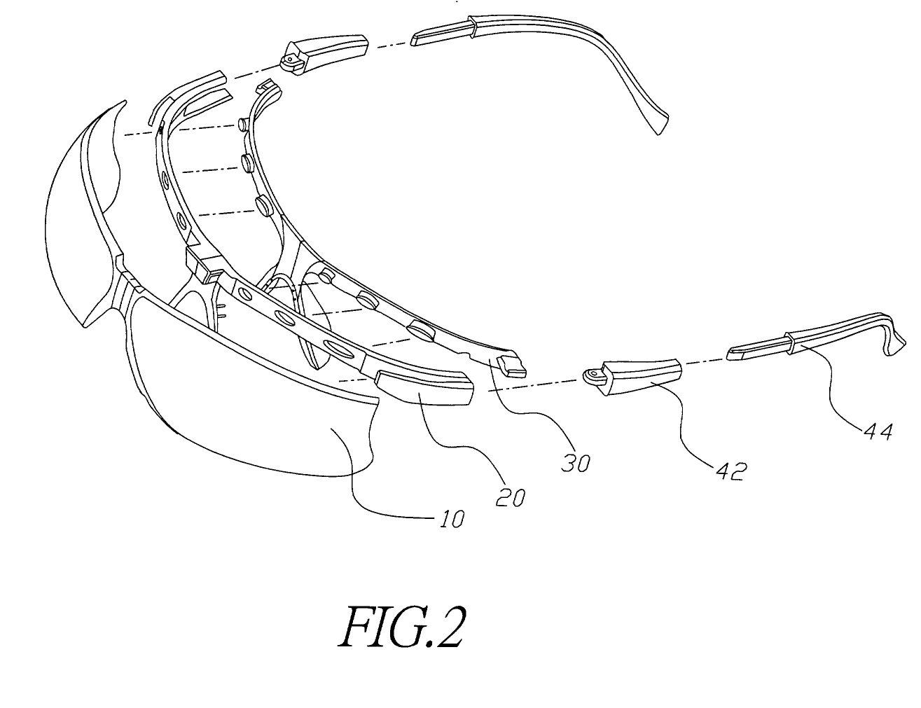

Reference to FIG. 2 is a decompose view illustrating the preferred embodiment in present invention. The eyeglasses comprising a frame 20, a pad 30 inside the frame, two front legs 42 connect to frame, respectively, two back legs 44 connect to two front legs, respectively, and a lens 10 placed outside the frame 20.

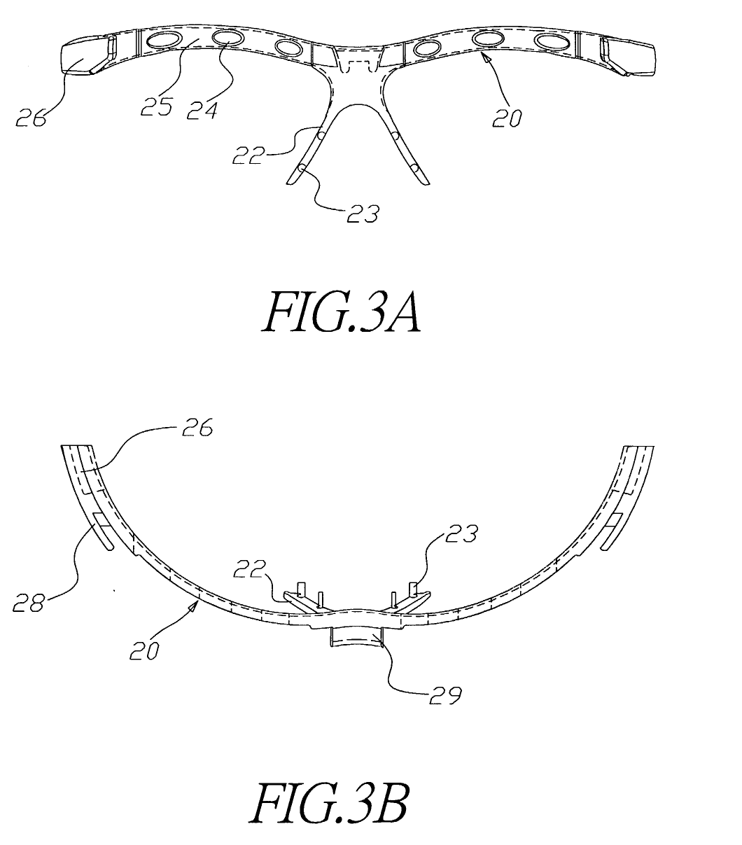

Reference to FIG. 3A and 3B show front and vertical views illustrating the frame of the preferred embodiment in present invention. In the middle of frame 20 has an inverted V nose stand 22. On the both sides of inverted V nose stand 22 have two pillars 23. There are six through holes 24 on the frame. Inside the frame 20 has a groove 25. On the both sides of frame 20 have a concave 26 and so the both sides extend to middle of frame 20 form a lens concave 28 match to inverted V nose stand 22 has a lens concave 29 for lens 10 place.

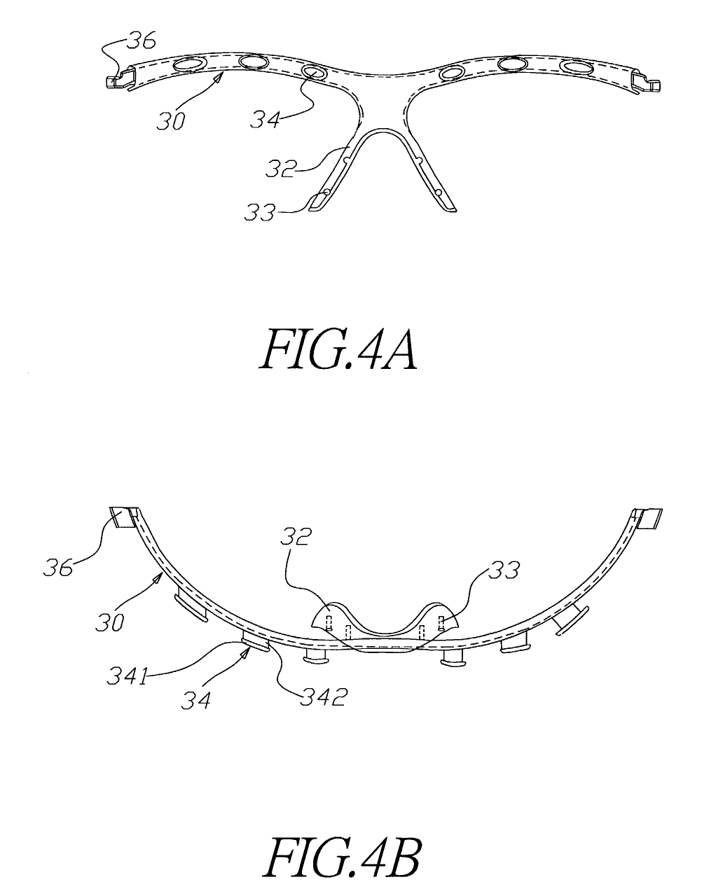

FIG. 4A and 4B show front and vertical views illustrating the pad 30 of the preferred embodiment in present invention. In the middle of pad 30 has an inverted V nose stand 32. On the both sides of inverted V nose stand 32 have two hold 33 connect to pillar 23 of frame 20. There are six lumps 34 in the pad 30 opposed to pillar 23 of frame 20, respectively. The lump 34 includes a front end 341 and a neck 342. The front end 341 is more expended then neck 342 for closing each other. Two ends of pad 30 has an infixed-flange 36 connect to a groove 26 of frame 20.

The present invention provides the frame 20 has a pillar 23 to connect hole 24 and groove 26, then, match to the insert-hole 33 of pad 30 and so the lump 34 connect to the infixed-flange 36. The thick and width of pad 30 match to groove 25. Then, both sides of the nose stand 32 of pad 30 overlay the both sides of the nose stand 22 of frame 20 tightly and firm. The pad 30 can be exchangeable, to matching different face, like sharp nose fit think pad, flat nose fit thick pad, even can be change different colors to increase practicability. For user, the exchangeable pad can be more comfortable and beautiful.

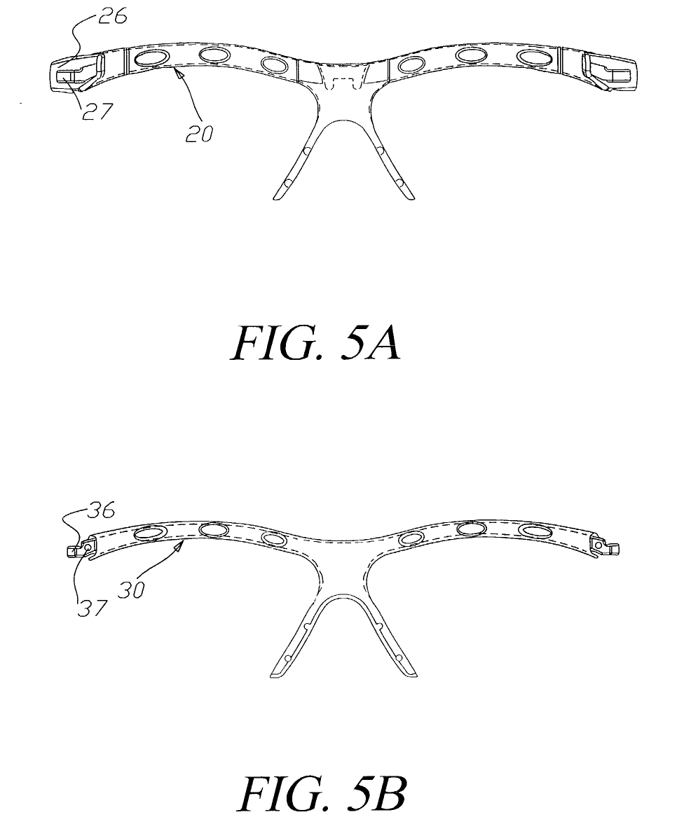

Reference to FIG. 5A and FIG. 5B show a front view illustrating the frame and the pad of another preferred embodiment in present invention. The character of the embodiment as FIG. 5A and FIG. 5B is two ends of frame 20 have a respective concave 26 with a respective connect-pillar 27. The infixed-flange 36 of pad 30 connect to connect-pillar 27 via connect-hole 37 on connect-pillar 27. As above described, the invention of present embodiment increase the intensity of connection, especially for low friction coefficient materials to make eyeglasses.

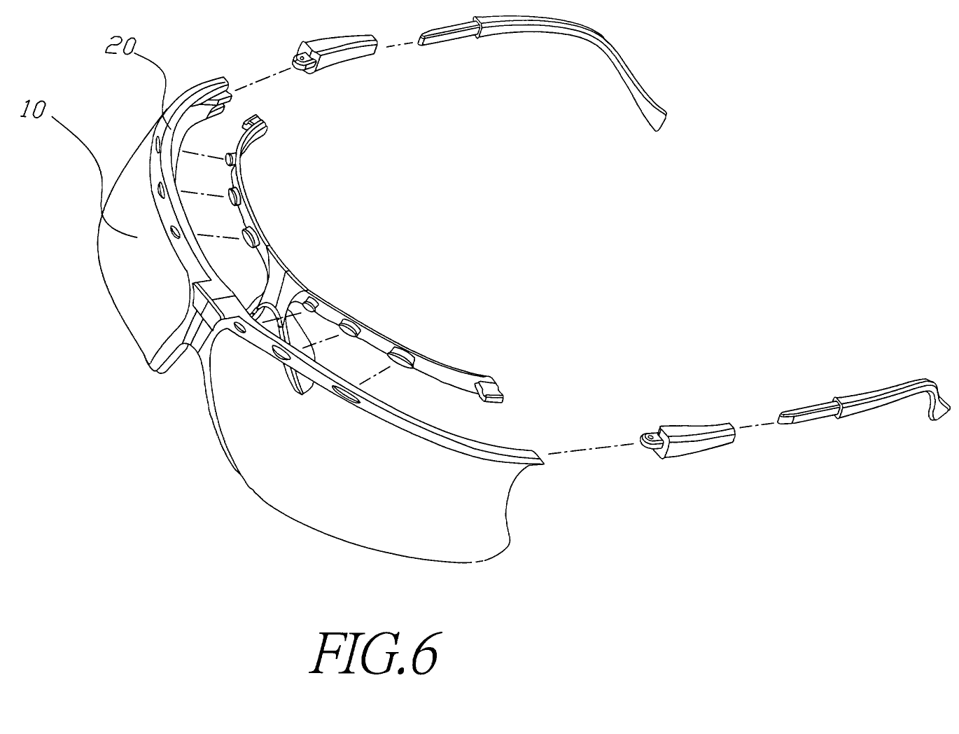

Reference to FIG. 6 is a decompose view illustrating another preferred embodiment in present invention. The frame 20 and lens 10 forms in one and so the frame does not need glasses grooves.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

What is claimed is:

1. A eyeglasses assembly, comprising
a frame having a inverted “V” type nose stand and a hole, wherein said inverted V nose stand is in the middle of frame, said hole on said frame, both sides of said frame individually have at least one pillar; and
a pad, placing inside of said frame, having a nose stand in opposite said inverted V nose and at least one insert hole connecting to said pillar, and said pad in opposite hole of said frame having a flange connecting to said hole of frame.

2. The eyeglasses assembly as claimed in claim 1, wherein said frame has a concave on both sides.

3. The eyeglasses assembly as claimed in claim 2, wherein said concave connects to infixed-flange on both sides of pad.

4. The eyeglasses assembly as claimed in claim 3, wherein said both sides of frame has a groove connecting to the connect-pillar.

5. The eyeglasses assembly as claimed in claim 4, wherein said connect-pillar on both sides of pad connects the connect-hole on infixed-flange on pad.

6. The eyeglasses assembly as claimed in claim 1, wherein said frame has a groove inside.

7. The eyeglasses assembly as claimed in claim 6, wherein said groove and pad match well on width and thick.

8. The eyeglasses assembly as claimed in claim 1, wherein said pad has a nose stand overlay the nose stand of frame.

9. The eyeglasses assembly as claimed in claim 1, wherein said nose of frame has a lens groove for putting lens.

10. The eyeglasses assembly as claimed in claim 1, wherein said frame has a lens groove from the both ends of frame extending to the middle of.

11. The eyeglasses assembly as claimed in claim 9, wherein said lens groove is for lens placed.

12. The eyeglasses assembly as claimed in claim 10, wherein said lens groove is for lens placed.

13. The eyeglasses assembly as claimed in claim 1, wherein said flange of pad includes a flange front end and neck, the front end is more protruded then neck.

14. The eyeglasses assembly as claimed in claim 1, wherein said frame and lens form in one.
